(19) United States
(12) Patent Application Publication
(10) Pub. No.: US 2004/0257238 A1
(43) Pub. Date: Dec. 23, 2004

(54) Virtual keyboard

(76) Inventor: Ronald Anton De Jongh, Sao Paulo (BR)

Correspondence Address: ARNOLD & PORTER LLP, ATTN: IP DOCKETING DEPT., 555 TWELFTH STREET, N.W., WASHINGTON, DC, 20004-1206, US

(21) Appl. No.: 10/784,897

(22) Filed: Feb. 24, 2004

(30) Foreign Application Priority Data
Feb. 25, 2003 (BR) PI 0300474-0

(51) Int. Cl. H04Q 1/00

(52) U.S. Cl. 340/825

(57) ABSTRACT

A virtual keyboard for typing the safety password, comprising the steps of displaying a multiple key keyboard; generating and assigning a predetermined number of characters to each one of the keys, such that the user selects a key which is associated with one of the predetermined number of characters; and displaying the predetermined number of characters in relative proximity to each one of the keys.

### FIELD OF THE INVENTION

The invention pertains to terminal machines. More particularly, the invention relates to terminal machines which utilize keyboard displays and a method of using the same.

### BACKGROUND OF THE INVENTION

As computers have become more predominant in everyday life, it becomes evident that business in the near future will be transacted, in a larger part, on the electronic superhighway or the Internet. The convenience of shopping the Internet and the utilization of e-commerce has already begun to permeate our lives. Credit card transactions and product orders on the Internet are now commonplace. However, along with this newfound convenience, system security, user identification, and validation of user identification remain legitimate and primary concerns for users of the current systems.

Automated teller machines (ATM) and Internet Banking allow bank customers to conduct banking transactions with financial institutions from remote locations anywhere in the world. Bank customers access their accounts via various technologies (including ATM and Internet Banking terminals) in order to transact business and obtain proprietary information regarding their accounts. As a security measure, the financial institution issues each bank customer a personal identification number or PIN. The bank customer enters the PIN into a keypad operatively connected to a card reader or other device which reads user identification information magnetically encoded onto the check or ATM card, credit card or the like. The PIN and the user information are then communicated to the network of the financial institution, which then verifies the accuracy of the information. Upon verification of the bank customer's PIN and user information, the bank customer is allowed to conduct business with the financial institution.

In today's marketplace, four requirements are paramount in granting access to an authorized user of a protected resource: (1) authorized user identification, (2) verification of authorized user identification, (3) unauthorized user access rejection and (4) an appropriate level of security to protect the resource from unauthorized use. For example, when a user (authorized or unauthorized) wishes to withdraw funds from an ATM, a bank issued card is inserted into the ATM and the “card” is identified via data transferred from a magnetic strip or an electronic chip within the card to a system database. To verify that the user is the authorized user of the bank issued card inserted into the ATM, the ATM prompts the user to enter a Personal Identification Number (PIN) which is only issued to the authorized user by the grantor of the bank card. If the PIN entered by the user is identical to the PIN issued to the authorized user and also recorded in system database memory, the user is verified as the authorized user and the transaction is allowed to proceed. The security afforded by this transaction involves possession of the bank card issued to the authorized user, knowledge of the PIN code, an upper limit cash demand and card deactivation if a consecutive series of incorrect PINs are entered into the ATM system. Theoretically, this security system is adequate to prevent an unauthorized user from gaining access to an account, but unfortunately, unauthorized access to protected resources has become a billion dollar problem. The resolution of this problem lies in understanding the weaknesses of the present systems and how to effectively eliminate those weaknesses while simultaneously maintaining simplicity, security and efficiency.

As the PIN system of security became the standard for verification of an authorized user in both card and non-card based systems, authorized users were subsequently required to recall a plurality of PIN codes in order to gain access to protected resources and services. This problem of excessive recall was resolved on the user level by recording PIN codes in writing and carrying a copy for easy reference in a wallet or purse. However, this was a direct compromise of the intended security afforded by the PIN system and could result in easy unauthorized access to related accounts if the wallet or purse was stolen. The recall problem was addressed on the grantor level by allowing the use of personalized PINs, for example various PINs, totally dynamic PINs and other overlapping security measures. In this way, an authorized user could eliminate recalling a multitude of PIN codes by making all PIN codes identical. In other words, personalized PINs allowed an authorized user to utilize a single PIN code for all protected resources, and additionally, a PIN of personal choice. However, if the personalized PIN was easy to guess, such as the authorized user's birth date or phone number, an informed unauthorized user could gain access to all protected resources with a single intelligent guess. Today, the major disadvantage of personalized PINs is the requirement of identical code lengths with constant and unchanging characters, usually numerals. If unauthorized use of a resource is obtained by observing the PIN entry of the authorized user, said unauthorized user instantly gains access to all resources protected by said personalized PINs. Therefore, personalized PINs decrease the personal security of the authorized user due to the possible windfall associated with gaining unlawful possession of the authorized user's wallet or purse and subsequent access to all resources protected by personalized PINs. Gaining access to the Internet and e-commerce environments with an increased level of security has changed access code requirements with respect to code length and the alphanumeric mix of code characters. Since many Internet sites now require access codes of eight or more characters with a minimum of two numerals, or instead issue a code of their choosing of varied lengths, personalized PINs only resolved the excess PIN memory overload problem for a short period of time.

There are numerous well known methods to secure the privacy of a bank customer's PIN. For example, in addition to fixed keypads, advancements in graphical user interface (GUI) technology permit a bank customer can enter his or her PIN on a keypad or touchscreen. The bank customer is able to shield a potential defrauder from misappropriating the PIN. Typically, terminal keyboards, which are known in the art, are always displayed on the terminals at the same position and with the same disposition of the keys. As a result, a defrauder can watch the movements carried out by the bank customer while the PIN is typed and, thereby, recognize the typed numbers, since the keys and the numbers are always displayed on the same location on the ATM's terminal screen.

In addition, certain defrauders use the artifice of cleaning the touchscreen of the ATM terminal before a bank customer makes use of it. Such artifice allows the identification of a user's PIN through his fingerprints, which remain printed on the touchscreen after typing. After the user leaves the ATM, the defrauder checks the fingerprints, discovering the numbers pressed by the user, since the keys and the numbers are always displayed at the same position on the ATM terminal.

The virtual keyboard of the present invention addresses these and other limitations of the prior art by employing a virtual keyboard that provides an image of a compact keyboard on a display screen of a ATM terminal, with the purpose of avoiding frauds after the safety password is typed, as described in the previous paragraphs.

### SUMMARY OF THE INVENTION

According to an embodiment of the invention, a method of providing access to electronic services via a secure access code. The method is characterized by displaying, via graphical user interface, a predetermined number of keys that are used to input the secure access code. The predetermined number of keys is associated with at least two variables. A user selects a key which corresponds to one of the variables associated with it.

According to another embodiment of the invention, a method of providing secure access. The method provides a plurality of keys by which a user can input a secure code and associates two or more variables with each of the plurality of keys, such that a user selects a key in accordance with the value of the variables, wherein the value of the variable is determined from a predetermined set of combinations, and that a user is assigned a random set of variable values upon the use of the machine.

According to another embodiment of the invention, a method of providing secure access. The method provides a graphical user interface, which allows a user to access secured electronic information, wherein the graphic user interface displays a number of keys, each key having at least two variables associated there with. The method further provides assigning variables from a group of possible combinations and associating those variables with each of the keys, such that the user gains the right to perform certain transactions by selecting keys which have assigned variables that correspond to a secret code.

According to another embodiment of the invention, a method of providing secure access. The method provides the steps of inserting a bank issued card into a terminal to execute a transaction; and displaying a selected keyboard to a user and requesting a personal identification number, such that the selected keyboard includes a predetermined number of keys, each individual key having at least two variables associated therewith.

### BRIEF DESCRIPTION OF THE DRAWINGS

In the accompanying drawings that form a part of the specification and are to be read in conjunction therewith, the present invention is illustrated by way of example and not limitation, with like reference numerals referring to like elements, wherein:

FIG. 1 illustrates an example of a virtual keyboard, according to an embodiment of the invention;

FIG. 2 illustrates another example of a virtual keyboard, according to an embodiment of the invention;

FIG. 3 illustrates yet another example of a virtual keyboard, according to an embodiment of the invention;

FIG. 4 is a further illustration of a virtual keyboard, according to an embodiment of the invention;

FIG. 5 is a further embodiment of a virtual keyboard, according to an embodiment of the invention;

FIG. 6 illustrates a flow diagram of an exemplary method, according to an embodiment of the invention; and

FIG. 6(a) is an illustration of listing of characters, according to an embodiment of the invention.

### DETAILED DESCRIPTION OF THE INVENTION

In the following detailed description, numerous specific details are set forth in order to provide a thorough understanding of the invention. However, it will be apparent to one of ordinary skill in the art that these specific details need not be used to practice the invention. In other instances, well known structures, interfaces, and processes have not been shown in detail in order not to unnecessarily obscure the invention.

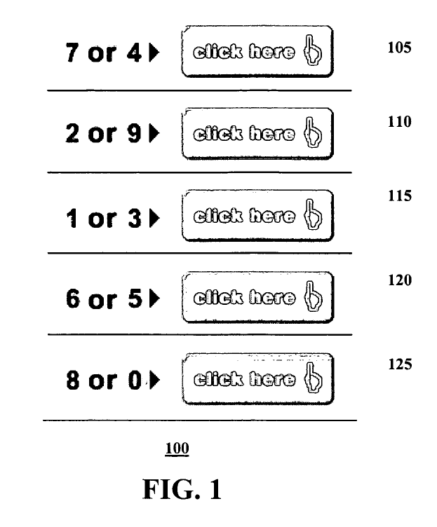

The method of the present invention, which may be software-implemented, consists of the generation of a virtual keyboard, as preferably illustrated in FIGS. 1 to 6, on a monitor of an ATM terminal or any other computer terminal, for example, a personal computer or a portable computer.

FIG. 1 illustrates a virtual keyboard 100, according to an embodiment of the invention. The virtual keyboard 100 provides five keys 105-125, however, one of ordinary skill in the art can readily appreciate that the figure is not meant to limit the scope of the invention and that any number of keys maybe utilized. Associated with each key 105-125 in the virtual keyboard 100, are a number of alphanumeric characters, which are displayed in relative proximity to each key 105-125. These characters are preferably numbers, as illustrated in the figure, but one of ordinary skill in the art can appreciate that they can also be combinations of letters, numbers or symbols. Also, one of ordinary skill in the art can appreciate that while the FIG. illustrates two characters associated with each key, this is not meant to limit the invention, but only for illustrative purposes.

As illustrated in FIG. 1, the alphanumeric characters 7 and 4 are assigned to the first key 105, the alphanumeric characters 2 and 9 are assigned to the second key 110, the alphanumeric characters 1 and 3 are assigned to the third key 115, the alphanumeric characters 6 and 5 are assigned to the fourth key 120 and the alphanumeric characters 8 and 0 are assigned to the fifth key 125. Accordingly, in order to enter a password (for example, 723604), the user presses the first key 105 through though the fifth key 125, and pressing the first key 105. One of ordinary skill in the art can appreciate that there may be various different permutations of values based on the keys pressed.

As illustrated in the figure, there are more than one number assigned to each key. Thus when a user depresses keys which are associated with elements of the password there is a process to determine which of the possible values entered is the correct password. For example, if the user depresses keys to enter 723604, there are numerous possible combinations of passwords that arise (e.g., 491587). The system determines the possible password by either using stored password or an encrypted password. For example, suppose a user's secret password is 723604, and the keypad is configured as shown in FIG. 1. If the password is stored at a central computer, then a comparison is made between the stored password and the values input by the user. The system knows that the user pressed the first key indicating that either 7 or 4 are the first value of the password. The value 7 and then the value 4 are compared with the stored password and the value that corresponds to the password is retained. A decision is made for each digit of the password, thereby resolving the distinction between different possible passwords. If there is no match, then an incorrect password has been entered and the user is notified as such. Another technique involves the possibility that a central computer does not have access to the password. When a user opens an account with a financial institution, they choose a password that is encrypted and the encrypted value of the password is stored by the financial institution. When the user presses the keys which are associated with the password, the system tests all possible combinations of the characters using the same encryption method (for example, Triple DES) and compare the results of the stored encrypted value with the combinations of encrypted values.

These alphanumeric characters are maybe displayed around each one of the keys so as to help the visualization thereof, however one of ordinary skill in the art can select other positions of the keys, for example, being represented inside each one of the virtual keys 105-125.

In accordance with the invention, the system includes multiple keys and various characters assigned to the keys. These features allow a user several layers of protection against eavesdroppers or other types of fraud. For example, with various characters assigned to each key, the amounts of combinations which must be deduced by a potential eavesdropper are considerable. If a user typed each key during the process of entering his PIN number, then the eavesdropper must determine which number the customer intended to include, but also the proper sequence of buttons. Therefore, the invention provides a double layer of protection against fraudulent activity.

When a user utilizes the electronic terminal, the virtual keyboard 100 is displayed on a touch-screen (not shown). One of ordinary skilled in the art will recognize that there are numerous methods of displaying information to a user and that the type of display is not meant to limit the invention.

The user identifies the generated characters, which are assigned to each one of the five keys, and depresses the keys which correspond to the values of the PIN in order to have access to the electronic transactions.

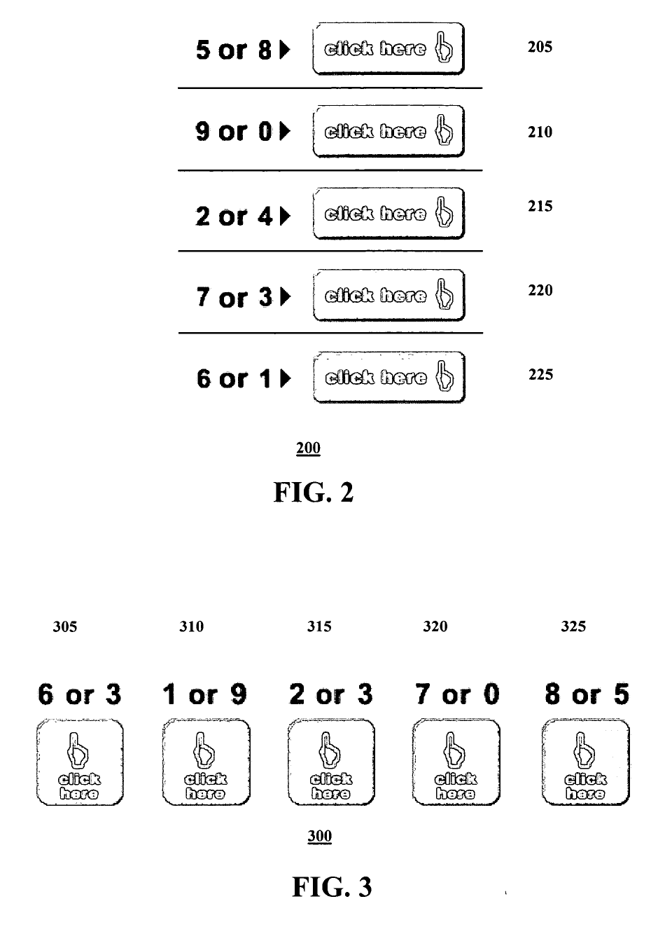

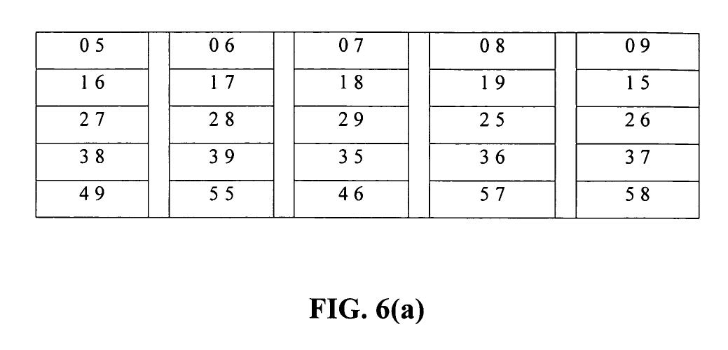

The keys 105-125 and associated characters together are regarded as one “screen.” The screen may change from user to user or after a predetermined period of time. A screen may be assigned to a user for certain period of time. One of ordinary skill in the art can appreciate the various types of scenarios which may be proposed. The only variable in each screen is the values of the characters assigned to each key. As displayed in FIGS. 1 and 2, the only difference between the figures is the values assigned to each key. For each screen there are ten total characters assigned to the keys. A central computer at a financial institution would store all the possible combinations of the ten characters that do not have repeating characters (for example, no two number 3's, because that would foster too much confusion among users and decipher the password). An example of the combinations of values is illustrated in FIG. 6(a). After a user's bank issued card has been authenticated, a screen is assigned to that user for a predetermined amount of time.

Typically, when a new user utilizes the terminal a new screen with a new combination of characters is displayed, the virtual keys remaining always at the same position. FIG. 2 illustrates a new virtual keyboard 200 with a new combination of characters, according to the embodiment of the invention. The virtual keyboard 200 provides five keys 205-225, however, one of ordinary skill in the art can readily appreciate that the figure is not meant to limit the scope of the invention and that any number of keys maybe utilized.

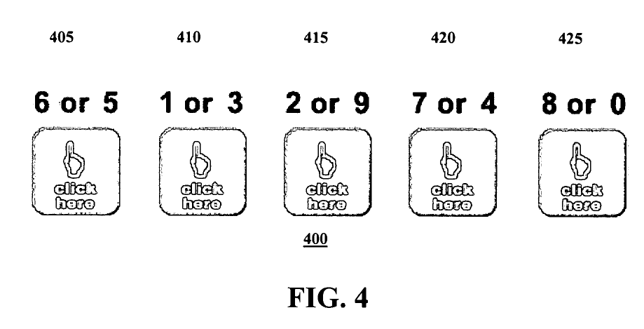

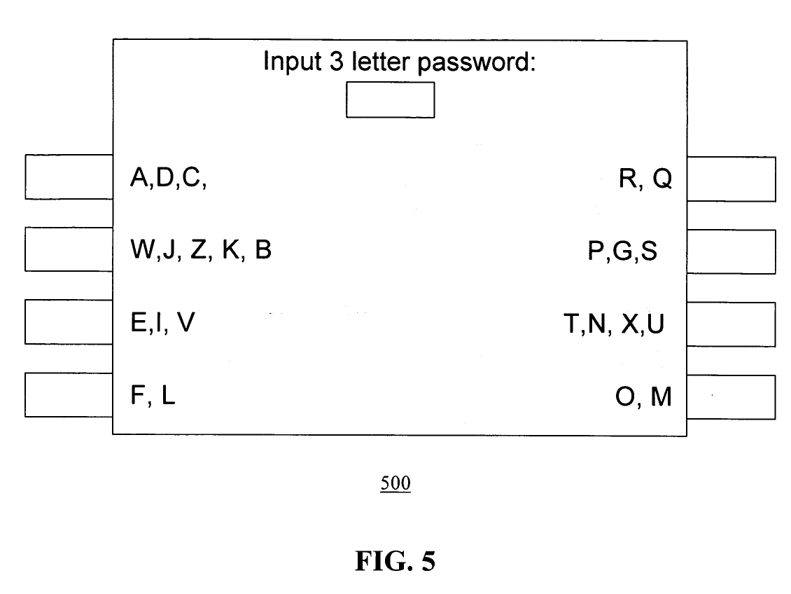

As will be shown in FIGS. 3 and 4, the disposition of the keys of the virtual keyboard 200 on the touch-screen may not be rigid. The keyboard 200 maybe customized to the preferences of the majority of the users. As illustrated, the only difference between FIG. 1 and FIG. 2 is the combination of characters assigned to each one of the five keys. For example, in FIG. 1, the virtual keys 105-125 which show the figure of a hand beside the text “click here” are displayed in the same position, however, the numbers displayed around each one of the virtual keys vary from user to user, as may be illustrated in FIG. 2, where the keys disposition is the same, but the combination of numbers is different. Therefore, FIGS. 1 and 2 show examples of virtual keyboards that would be displayed to two distinct users.

FIG. 3 illustrates a virtual keyboard 300, according to an embodiment of the invention. The virtual keyboard 300 provides five keys 305-325, however, one of ordinary skill in the art can readily appreciate that the figure is not meant to limit the scope of the invention and that any number of keys maybe utilized. Associated with each key 305-325 in the keyboard 300, are pairs of characters, which are displayed around or inside each key 305-325. These characters are preferably numbers, as illustrated in the figure, but one of ordinary skill in the art can appreciate that they can also be combinations of letters or of letters and numbers. As shown in the figure, the keys 305-325 are display in a horizontal configuration across the screen.

FIG. 4 also illustrates a horizontal configuration of the keyboard 400. However, FIG. 4 illustrates a keyboard 400 in which the characters assigned to each key 405-425 have been reconfigured to be displayed to a new user.

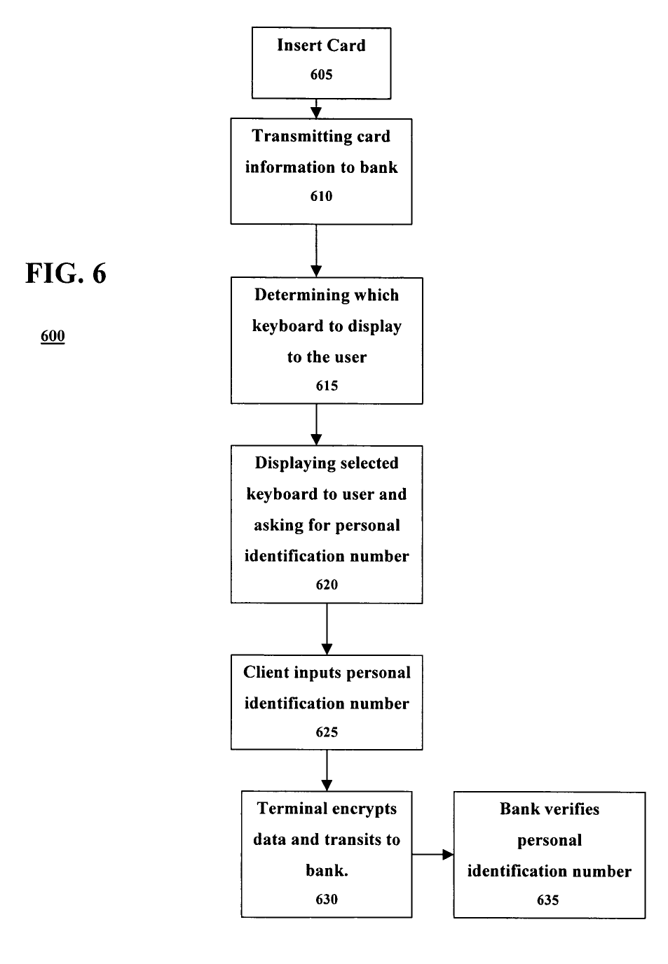

FIG. 5 illustrates an alternate embodiment of the invention. The figure illustrates a keyboard 500, which has the keys outside of the screen. The screen illustrates various characters which represent elements of a personal identification number (PIN) and a box which shows the selected characters. The keys are lined up in a manner such that as to be associated with various characters. For example, the first key (on the top left) is associated with the characters A, D and C. The characters A, D and C are shown on the screen. The screen illustrates the characters and a box that would indicate the number of characters has been depressed. A user would select the button that corresponded to the element of the PIN and either the number or a character would appear in the box.

FIG. 6 illustrates a flow diagram of a method 600 of accessing a secured terminal, according to an embodiment of the invention. In step 605, a user approaches the terminal, decides to perform at least one banking transaction via the terminal and inserts a bank issued card into the terminal machine.

In step 610, the terminal reads information from the bank issued card and transmits it to a bank computer (not shown). Typically, the information is encrypted according to a well-known encryption method. The bank computer determines and logs that the user who is associated with the bankcard is using a terminal machine.

In step 615, the system determines which keypad will be displayed to the user. Because the user selects a key which corresponds to at least two characters, there are a certain number values which can be associated with each key. For example, there are two characters associated with each key (as shown in FIGS. 1). The computer stores predetermined lists of characters such that no single number is assigned twice to the same key. Each “screen” contains two columns of numbers between 0-9. There are 945 possible combinations of screens that exist.

In step 620, the bank computer selects a screen at random and displays the screen to user, in a manner similar to FIGS. 1 and 2.

In step 625, the user inputs the secret password. The user depresses the keys which a numbers associated with the secret passwords.

In step 630, the terminal machine encrypts the data associated with secret password and transmits it to the bank computer. The data is encrypted in a manner known to one of ordinary skill in the art.

In step 635, the bank computer verifies the user's secret password information and allows the user to perform predetermined banking transactions with the bank.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

We claim:

1. Method of providing access to electronic services via a secure access code, characterized by comprising the steps of:
displaying, via graphical user interface, a predetermined number of keys which are used to input the secure access code;
associating at least two variables with each individual key;
selecting, by the user, a key which corresponds to at least one of the variables.

2. Method of claim 1, wherein the predetermined number of characters assigned to each variable are alphanumeric characters.

3. The method of claim 1, wherein the variables are numbers.

4. The method of claim 1, wherein the variables are letters.

5. The method of claim 1, wherein the variables are a combination of letters and numbers.

6. The method of claim 1, wherein the variables are symbols.

7. Method of claim 1, wherein the predetermined number of characters are generated by a predetermined sequence.

8. The method of claim 7, wherein the variable are generated in accordance with a predetermined random sequence of combination of values.

9. The method of claim 8, wherein one combination is selected and displayed for each user.

10. Method of claim 1, wherein the user selects keys which are associated with the variables that correspond to the access code.

11. Method of claim 1, wherein the upon the successful verification of the access code, the user has access to a plurality of electronic services.

12. A virtual keyboard comprising:
a predetermined number of keys for inputting an access code; and
a predetermined number of variables associated with each key, wherein the user selects a key based on whether the variables correspond with some portion of the user's access code.

13. The virtual keyboard of claim 12, wherein there are at least two variables associated with key.

14. The virtual keyboard of claim 13, wherein the variables are numbers.

15. The virtual keyboard of claim 13, wherein the variables are letters.

16. The virtual keyboard of claim 13, wherein the variables are a combination of letters or numbers.

17. The virtual keyboard of claim 13, wherein the variables are symbols.

18. The virtual keyboard of claim 13, wherein the variable are generated in accordance with a predetermined random sequence of combination of values.

19. The virtual keyboard of claim 13, wherein one combination is selected and displayed for each user.

20. The virtual keyboard of claim 12, where the user's access code is input by selecting the keys which are associated with values that correspond to the access code.

21. A keypad, comprising:
a plurality of keys, such that a user selects with the plurality of keys in such a manner as to input information; and
a plurality of characters associated with each key of the plurality of keys, wherein the plurality of characters are representative individual elements of a secret codeword.

22. A method of providing secure access, comprising the steps of:
providing a plurality of keys by which a user can input a secure code; and
associating two or more variables with each of the plurality of keys, such that a user selects a key in accordance with the value of the variables, wherein the value of the variable are determined from a predetermined set of combinations, and that a user is assigned a random set of variable values upon the use of the machine.

23. A secure access terminal comprising;
a graphical user interface, which allows a user to access secured electronic information, wherein the graphic user interface displays five keys, each key having at least two variables associated there with; and
assigning the variables from a group of possible combinations of variables and associating those variable with each of the keys, such that the user gains the right to perform certain transactions by selecting keys which have assigned variables that correspond to a secret code.

24. A method for providing access to a secured terminal comprising the steps of:
inserting a bank issued card into a terminal to execute a transaction; and
displaying a selected keyboard to a user and requesting a personal identification number, such that the selected keyboard includes a predetermined number of keys, each individual key having at least two variables associated therewith.

25. The method of claim 24, further comprising the steps of:
transmitting card information to a server;
verifying the authenticity of the bank issued card; and
determining which keyboard to display to the user.

26. The method of claim 24, further comprising the steps of:
client inputs a personal identification number;
encrypting the personal identification number data and transmitting the data to a server; and
verifying the personal identification number and allowing a user to access various banking functions.

27. The method of claim 24, wherein there are at least two variables associated with key.

28. The method of claim 24, wherein the variables are numbers.

29. The method of claim 24, wherein the variables are letters.

30. The method of claim 24, wherein the variables are a combination of letters or numbers.

31. The virtual keyboard of claim 24, wherein the variables are symbols.
